(19) United States
(12) Patent Application Publication
(10) Pub. No.: US 2005/0170724 A1
(43) Pub. Date: Aug. 4, 2005

(54) Process for preparing high-strength pe tarpaulin

(76) Inventor: Yung-Sang Ki, Seoul (KR)

Correspondence Address: JONES DAY, 222 EAST 41ST ST, NEW YORK, NY, 10017, US

(21) Appl. No.: 10/512,450

(22) PCT Filed: Apr. 22, 2003
(86) PCT No.: PCT/KR03/00817

(30) Foreign Application Priority Data
Apr. 22, 2002 (KR) 10-2002-21850

(51) Int. Cl. B32B 5/02; B32B 27/04; B32B 27/12; D03D 15/00

(52) U.S. Cl. 442/189; 442/192; 442/86; 442/85; 442/217

(57) ABSTRACT

The present invention relates to a PE tarpaulin prepared by coating low-density polyethylene on both surfaces of a cloth woven by using drawn yarns (flat yarns) having higher fiber strength than a general PE tarpaulin by appropriately mixing high density polyethylene and polypropylene, and a process for preparing the same. The PE tarpaulin shows higher mechanical strength than general PE tarpaulin.

### TECHNICAL FIELD

The present invention relates to a PE tarpaulin prepared by coating low-density polyethylene on both surfaces of a woven cloth, and a process for preparing the same, and more particularly to, a PE tarpaulin prepared by coating low-density polyethylene on both sides of a cloth woven by using drawn yarns (flat yarns) prepared by appropriately mixing high-density polyethylene and polypropylene to have higher fiber strength than a general PE tarpaulin, and a process for preparing the same, so that the PE tarpaulin can have higher mechanical strength than the general PE tarpaulin.

### BACKGROUND ART

In general, a tarpaulin has reduced the production cost and improved productivity by multiple-coating low-density polyethylene resin on a layer woven by using high-density polyethylene (HDPE). Recently, there has been taught a process for preparing a tarpaulin by stacking low-density polyethylene (LDPE) resin on one or both surfaces of a layer woven by using HDPE, and compressing and coating it by using a cooling roller and a pressure roller (Korean Patent Application No. 2001-28151, May 22, 2001).

In addition, Korean Patent Application No. 2000-34801 (Jun. 23, 2000) of the present inventor has disclosed a tarpaulin using HDPE split yarns and a process for preparing the same. Here, the tarpaulin used for various purposes including a waterproof cloth such as a waterproof tent is classified into a polyvinyl chloride (PVC) tarpaulin and a polyethylene (PE) tarpaulin according to the quality of a woven cloth. The PVC tarpaulin is prepared by coating PVC on both surfaces of a PET woven cloth composed of multi-filament yarns, and the PE tarpaulin is prepared by coating LDPE on both surfaces of HDPE tape yarns.

FIG. 1 is a schematic view showing a process for preparing flat yarns by using HDPE resin used as a main material of the PE tarpaulin. Referring to FIG. 1, substances 21 mixed in a dry mixer 1 are supplied to a hopper 2 of an extruder, molten, roll-mixed and homogenized in the extruder, and extruded through a circular die 4. The mixed substances are cooled and solidified in the form of a tube 22, and folded in two by a pinch roll to form a twofold film. The twofold film is divided into two films by a primary knife, and slit by a secondary knife in a predetermined width. The slit films are drawn on a drawing plate between a chill roll and a pressure roll, and annealed between the pressure roll and a third roll for size stability. The thusly-prepared flat yarns have much higher tenacity than films.

In FIG. 1, a T-die can be used instead of the circular die. The flat yarns prepared by using the T-die show higher tenacity than the flat yarns prepared by using the circular die by about 20 to 30%.

As described above, the flat yarns prepared by using HDPE have tenacity of 2.5 to 3.5 g/D. Accordingly, the PE tarpaulin prepared by coating LDPE on both sides of the cloth woven by using the flat yarns shows very low mechanical strength, and thus uses thereof are extremely limitative.

The present inventor made every effort to improve mechanical strength of the general PE tarpaulin, and found out that the aforementioned object could be achieved by employing a cloth woven by using flat yarns prepared by mixing high-density polyethylene and polypropylene as a main material, or using a cloth woven by periodically overlapping two flat yarns (partial overlap yarn structure) in wefts and warps as the main material.

### DISCLOSURE OF THE INVENTION

An object of the present invention is to provide a PE tarpaulin which can be used for industrial purposes by obtaining much higher mechanical strength, especially higher tearing strength than a general PE tarpaulin.

In order to achieve the above-described object of the invention, there is provided a PE tarpaulin prepared by changing quality of the flat yarns composing a woven cloth used as a main material, or a process for weaving a cloth.

### BRIEF DESCRIPTION OF THE DRAWINGS

FIG. 1 is a schematic view showing a process for preparing general drawn yarns (flat yarns); and

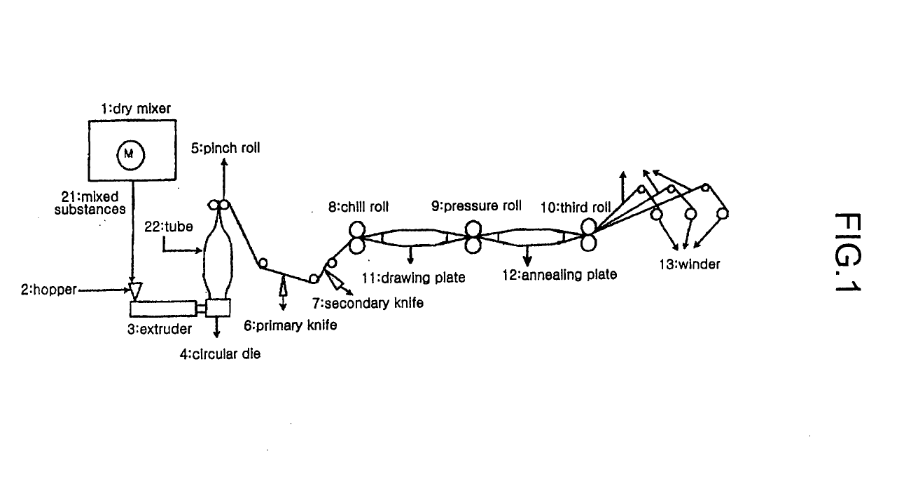

FIG. 2 is a cross-sectional view illustrating a PE tarpaulin.

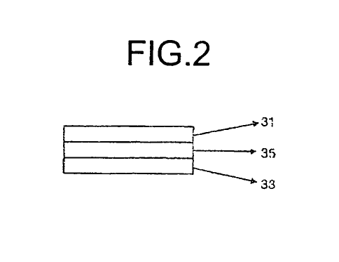

### BEST MODE FOR CARRYING OUT THE INVENTION

A process for preparing a high-strength PE tarpaulin in accordance with the present invention will now be described in detail with reference to the accompanying drawings.

A process for weaving a resin and cloth to provide a PE tarpaulin having sufficient mechanical strength to be used for industrial purposes will now be explained.

Flat yarns are prepared by mixing (A) high-density polyethylene and (B) polypropylene. Here, a melting index of component (A) measured at 190° C. with a load of 2.16 kg ranges from 0.6 to 1.2 g/10 min. When the melting index is lower than 0.6 g/10 min., load increases and an extruded amount decreases during an extruding process, and when it is higher than 1.2 g/10 min., stability of substances extruded from a die decreases due to low tension in a melting state, and tenacity decreases due to low molecular weight.

Component (B) is polypropylene homo polymer. A melting index of component (B) measured at 230° C. with a load of 2.16 kg ranges from 1.5 to 3.5 g/10 min. When the melting index is lower than 1.5 g/10 min, it is not well mixed with component (A) in a melting state, and when it is higher than 3.5 g/10 min, component (B) shows low molecular weight like component (A), and thus fails to improve tenacity.

Differently from a general process for weaving a cloth for a PE tarpaulin, the process of the present invention forms partial overlap yarn structures in wefts and warps. In the partial overlap yarn process, a density of weaving twofold flat yarns is preferably 3 to 6 per 1 inch of weft and warp. When the density of the overlap yarn structure is smaller than 3, tenacity is rarely improved, and when it is greater than 6, the weight of the cloth and the weaving cost seriously increase.

In order to prepare the flat yarns, a variety of additives can be added to components (A) and (B) within the range of maintaining the scope of the invention. For example, agents for improving compatibility of components (A) and (B) in a melting state, such as thermoplastic elastomers containing ethylene and propylene, various inorganic fillers, master batches thereof, ultraviolet ray stabilizers, antioxidants, antistatic agents, organic or inorganic coloring agents, and master batches thereof can be appropriately used.

The present invention will now be explained in detail by referring to following examples, which are not intended to be limiting.

### INVENTION EXAMPLES AND COMPARATIVE EXAMPLES

Table 1 shows test results of Invention Examples and Comparative Examples on the flat yarns prepared by the process of the invention, and Table 2 shows test results of mechanical properties of a PE tarpaulin woven to have overlap yarn structures by using the flat yarns of the invention and a general PE tarpaulin.

In the following tables, tenacity of the flat yarns was measured according to KS K0409, and tenacity and tearing strength of the PE tarpaulin were measured according to KS K0520 and KS K0536.

TABLE 1

| | Component | Component | | Tenacity |
|---|---|---|---|---|
| | (A) | (B) | Agents | (g/Denier) |
| Invention Example 1 | 50 | 50 | 0 | 4.3 |
| Invention Example 2 | 30 | 70 | 0 | 4.4 |
| Invention Example 3 | 47 | 50 | 3 | 3.9 |
| Invention Example 4 | 27 | 70 | 3 | 4.7 |

| | | |
|---|---|---|
| Comparative | High-density polyethylene | 2.8 |
| Example 1 | | |
| Comparative | High-density polyethylene | 3.4 |
| Example 2 | | |

* Drawing ratio of flat yarn preparation is all 7 to 1.
* Difference between Comparative Examples 1 and 2: different HDPE manufacturing companies

TABLE 2

| | |
|---|---|
| | Tearing strength |
| Tenacity (kgf) | (kgf) |

| | Warp | Weft | Warp | Weft |
|---|---|---|---|---|
| Invention Example 1 | 120 | 100 | 35 | 36 |
| Invention Example 2 | 85 | 75 | 25 | 25 |
| Comparative Example 1 | 84 | 80 | 16 | 14 |
| Comparative Example 2 | 65 | 53 | 12 | 14 |

* Invention Example 1: 4 overlap yarn structures per 1 inch of weft and warp.
Density of woven cloth is 1200 × 1200 denier, 12 × 12/inch².
* Invention Example 2: 4 overlap yarn structures per 1 inch of weft and warp.
Density of woven cloth is 850 × 850 denier, 12 × 12/inch².
* Comparative Example 1: cloth woven by general process.
Density of woven cloth is 1200 × 1200 denier, 12 × 12/inch².
* Comparative Example 2: cloth woven by general process.
Density of woven cloth is 850 × 850 denier, 12 × 12/inch².

### INDUSTRIAL APPLICABILITY

As described above, in accordance with the present invention, the PE tarpaulin prepared by forming the flat yarns and using the cloth woven to have overlap yarn structures has high mechanical strength, especially high tearing strength, and thus is suitable for industrial purposes.

1. A PE tarpaulin prepared by coating low-density polyethylene on both surfaces of a main material cloth woven to have partial overlap yarn structures by periodically overlapping in weft and warp directions two flat yarns prepared by mixing 30 to 50 wt % of high-density polyethylene and 70 to 50 wt % of polypropylene homo polymer in 100 wt % of flat yarns which are drawing yarns.

2. The PE tarpaulin of claim 1, wherein a melting index of high-density polyethylene measured at 190° C. with a load of 2.16 kg ranges from 0.6 to 1.2 g/10 min.

3. The PE tarpaulin of claim 1, wherein a melting index of polypropylene homo polymer measured at 230° C. with a load of 2.16 kg ranges from 1.5 to 3.5 g/10 min.

4. The PE tarpaulin of claim 1, wherein, when the cloth is woven by using the flat yarns, wefts and warps have partial overlap yarn structures, and a density of the overlap yarn structures is 3 to 6 per 1 inch of weft and warp.
